(19) United States
(12) Patent Application Publication
(10) Pub. No.: US 2013/0178172 A1
(43) Pub. Date: Jul. 11, 2013

(54) TUNABLE WIRELESS ANTENNA FOR INFORMATION HANDLING DEVICE WIRELESS COMMUNICATION

(71) Applicants: James S. Rutledge, Durham, NC (US); Steven R. Perrin, Raleigh, NC (US); Kazuo Fujii, Kanagawa-ken (JP); Mitsuhiro Yamazaki, Kanagawa-ken (JP); Takayuki Katoh, Yokohama (JP)

(72) Inventors: James S. Rutledge, Durham, NC (US); Steven R. Perrin, Raleigh, NC (US); Kazuo Fujii, Kanagawa-ken (JP); Mitsuhiro Yamazaki, Kanagawa-ken (JP); Takayuki Katoh, Yokohama (JP)

(21) Appl. No.: 13/343,830

(22) Filed: Jan. 5, 2012

(51) Int. Cl. H04W 88/06; H04B 1/40

(52) U.S. Cl. 455/77

(57) ABSTRACT

Systems, methods and products directed toward tuning a wireless antenna of an information handling device are disclosed herein. One aspect includes tuning one or more wireless antennas connected to an information handling device via one or more antenna tuning pins arranged within a system bus slot; wherein the one or more antenna tuning pins are configured to tune the one or more wireless antennas to operate within a frequency band based on one or more connections with one or more wireless communication pins of a device interface module arranged to interface with the system bus slot. Other embodiments are described herein.

### BACKGROUND

Consumer electronic devices, such as laptop computers and smartphones, may employ multiple frequency ranges for wireless communication. Exemplary frequency ranges include the Wi-Fi (2.4, 3.6, and 4.9/5.0 GHz), WWAN (870-890, 925-960, and 1800-1880 MHz), WPAN (2.4 GHz), WiMAX (2.3, 3.4-3.6, and 5.7-5.8 GHz), third generation (3G) (1.8-2.5 GHz), fourth generation (4G) (2-8 GHz), and Global System for Mobile Communication (GSM) (850 MHz-1.8 GHz) frequency bands. Wireless communication may be facilitated through one or more antennas and wireless communication modules disposed within the device. An example of a wireless communication module is an integral or expansion wireless communication card, such as a 3G Peripheral Component Interconnect Express (PCIe) card.

There is increasing demand to provide computing devices that support multiple frequency bands. However, there are many challenges associated with integrating multiple communication modules and antennas within the restricted space and layout of a consumer electronic device, especially without prohibitively increasing manufacturing costs.

### BRIEF SUMMARY

In summary, one aspect provides an information handling device comprising: one or more processors; a memory in operative connection with the one or more processors one or more memories storing program instructions accessible by the one or more processors; one or more wireless antennas; and a system bus slot comprising one or more antenna tuning pins configured to tune the one or more wireless antennas to operate within a frequency band based on one or more connections with one or more wireless communication pins of a device interface module; wherein, responsive to execution of program instructions accessible to the one or more processors, the one or more processors are configured to execute wireless communications for the information handling device utilizing the one or more wireless antennas operating within the frequency band.

Another aspect provides a hybrid information handling device comprising: a first processor configured to operate within a primary environment; a second processor arranged within a device interface module and configured to operate within a secondary environment; one or more memories storing program instructions accessible by the first and second processors; one or more wireless antennas; a system bus slot comprising one or more antenna tuning pins configured to tune the one or more wireless antennas based on one or more connections with one or more wireless communication pins of the device interface module; wherein the hybrid information device is configured to switch between the primary environment and the secondary environment; wherein, responsive to execution of program instructions accessible to the first processor, the first processor is configured to execute wireless communications for the information handling device utilizing the one or more wireless antennas operating within a primary environment wireless communication frequency band; wherein, responsive to execution of program instructions accessible to the second processor, the second processor is configured to execute wireless communications for the information handling device utilizing the one or more wireless antennas operating within a SE wireless communication frequency band.

A further aspect provides a method comprising: tuning one or more wireless antennas connected to an information handling device via one or more antenna tuning pins arranged within a system bus slot; wherein the one or more antenna tuning pins are configured to tune the one or more wireless antennas to operate within a frequency band based on one or more connections with one or more wireless communication pins of a device interface module arranged to interface with the system bus slot.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 provides an example information handling device configured according to an embodiment.

FIG. 2 provides another example information handling device configured according to an embodiment.

FIG. 3 provides an example diagram of a standard bus PCIe slot pin-out configuration and pin-out configurations according to embodiments.

FIG. 4 provides an example pin-out for providing audio and/or video signals according to an embodiment.

FIG. 5 illustrates an example circuitry of an information handling device system.

FIG. 6 illustrates another example circuitry of an information handling device system.

FIG. 7 illustrates an example hybrid information handling device environment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

Information handling devices may be configured to communicate through wireless communication technology operating within one or more frequency ranges. Illustrative and non-restrictive wireless communication technologies include Wi-Fi (2.4, 3.6, and 4.9/5.0 GHz), WWAN (870-890, 925-960, and 1800-1880 MHz), WPAN (2.4 GHz), WiMAX (2.3, 3.4-3.6, and 5.7-5.8 GHz), third generation (3G) (1.8-2.5 GHz), fourth generation (4G) (2-8 GHz), and Global System for Mobile Communication (GSM) (850 MHz-1.8 GHz). There is an increasing demand to provide information handling devices that support multiple wireless communication technologies. However, there are many challenges associated with integrating multiple wireless communication technologies into a single device.

For example, multiple antennas may be required to handle the frequency ranges of each supported wireless communication technology. However, there are space and layout restrictions that may prohibit or severely limit the number and type of antennas that may be embedded within a particular information handling device. In addition, inadequate spacing between antennas and large antenna size may introduce radio wave interference within the device.

Multiple wireless communication technologies may be supported through one or more multi-band antennas (e.g., dual-band, penta-band, etc.) configured to handle more than one frequency band. For example, a multi-band antenna may operate at the 3G and 4G frequency bands. However, configuring the system board and/or antenna of an information handling device to operate with multiple wireless communication modules according to existing technology may prohibitively increase the costs of manufacturing the device. For example, significant costs may be incurred because the information handling device may have to incorporate multiple system bus connections or one or more high cost gain switches. In addition, a multi-band antenna capable of operating multiple frequency bands according to present methods may be too large, such that interference may be introduced back into the system, severely affecting performance.

Embodiments provide for utilizing a standard bus slot disposed within an information handling device configured to support a multiplicity of device interface modules and wireless communication technologies associated therewith. According to embodiments, a multi-band wireless antenna located within the information handling device may be tuned to operate according to the wireless communication technology associated with a device interface module connected to the standard bus slot. The standard bus slot may be comprised of one or more wireless communication pins arranged to tune a multi-band antenna to one or more frequency bands. According to embodiments, a device interface module may be configured with a set of pins that interface, inter alia, with the wireless communication pins of the standard system bus slot. Embodiments provide that the multi-band antenna may be tuned to the frequency band designated by the wireless communication pins connected to the pins of the device interface module.

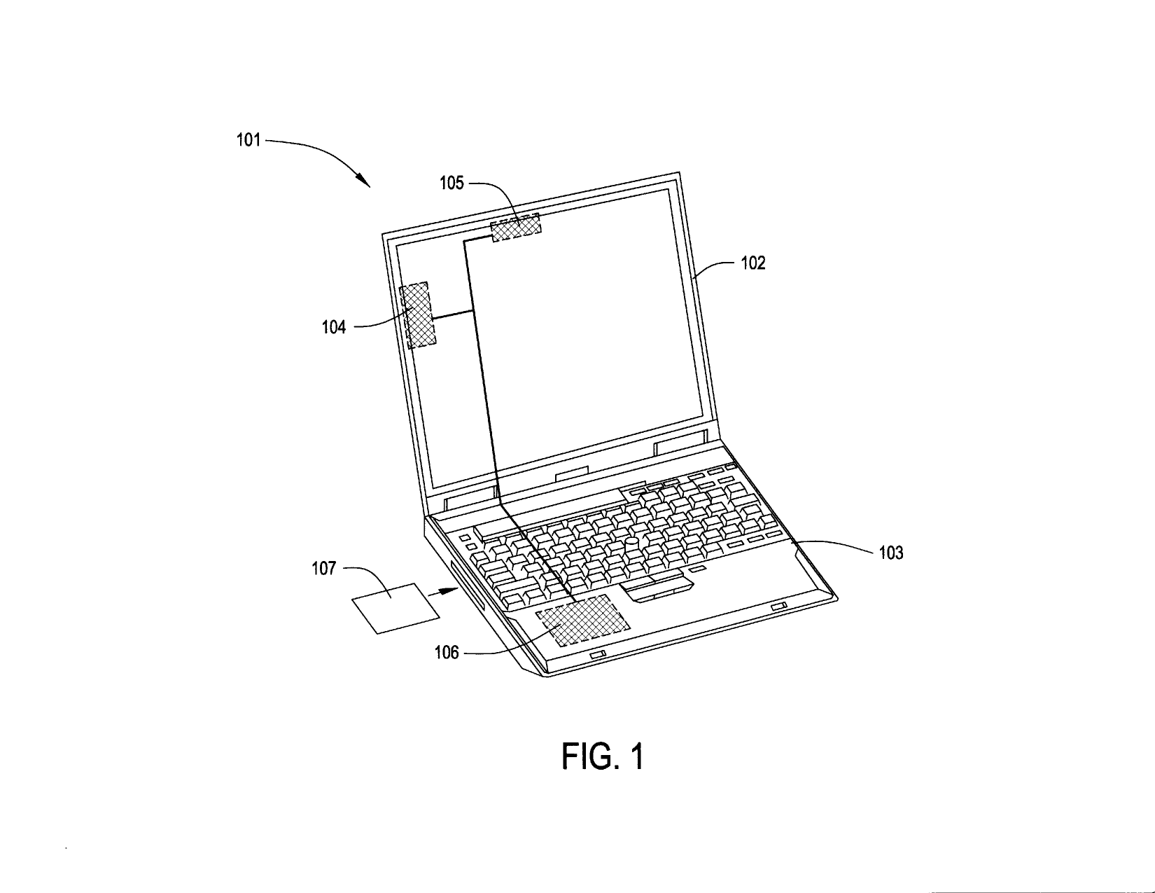

Referring to FIG. 1, therein is provided an example information handling device configured according to an embodiment. The information handling device 101 may be a laptop computer arranged in a clamshell form factor having a base portion 102 and a display portion 103. Embodiments provide that the information handling device 101 may be configured as a hybrid information handling device comprising a primary environment (PE) (for example, a Win-Tel platform) and a secondary environment (SE) (for example, an ARM-based platform), as described further below.

Wireless communication may be facilitated in the information handling device 101 through one or more antennas 104, 105 and one or more device interface modules 106, 107 that, inter alia, support wireless communication. The one or more antennas 104, 105 may be embedded within the information handling device 101, for example, in a side (e.g., 104) or top (e.g., 105) region of the display portion 103. As a non-limiting example, the one or more antennas may be multi-band (e.g., pentaband) antennas that support 3G and 4G frequency bands, but which may be tuned to support other wireless communication technologies (e.g., Wi-Fi).

The one or more device interface modules 106, 107 may be configured as an interface card or adapter, for example, as an integral 106 or an expansion 107 module, located within the base portion 102. According to embodiments, the device interface card may be arranged as a “system on a chip” (SOC), comprising a processor (e.g., an ARM series processor, such as the SNAPDRAGON BY QUALCOMM CPU) and related hardware, firmware, and may additionally support one or more wireless communication technologies (e.g., Wi-Fi, 3G). SNAPDRAGON BY QUALCOMM is a registered trademark of Qualcomm Incorporated in the United States and/or other countries.

Each of the one or more device interface modules 106, 107 may interact with the information handling device 101 through a bus standard, including, but not limited to, Peripheral Component Interconnect (PCI), PCI Express (PCIe), or Mini PCIe. Non-limiting examples of device interface modules 106, 107 include modules configured to support Wi-Fi, wireless wide area network (WWAN), wireless personal area network (WPAN), WiMAX, 3G, 4G, Global System for Mobile Communication (GSM), SOC systems, and combinations thereof.

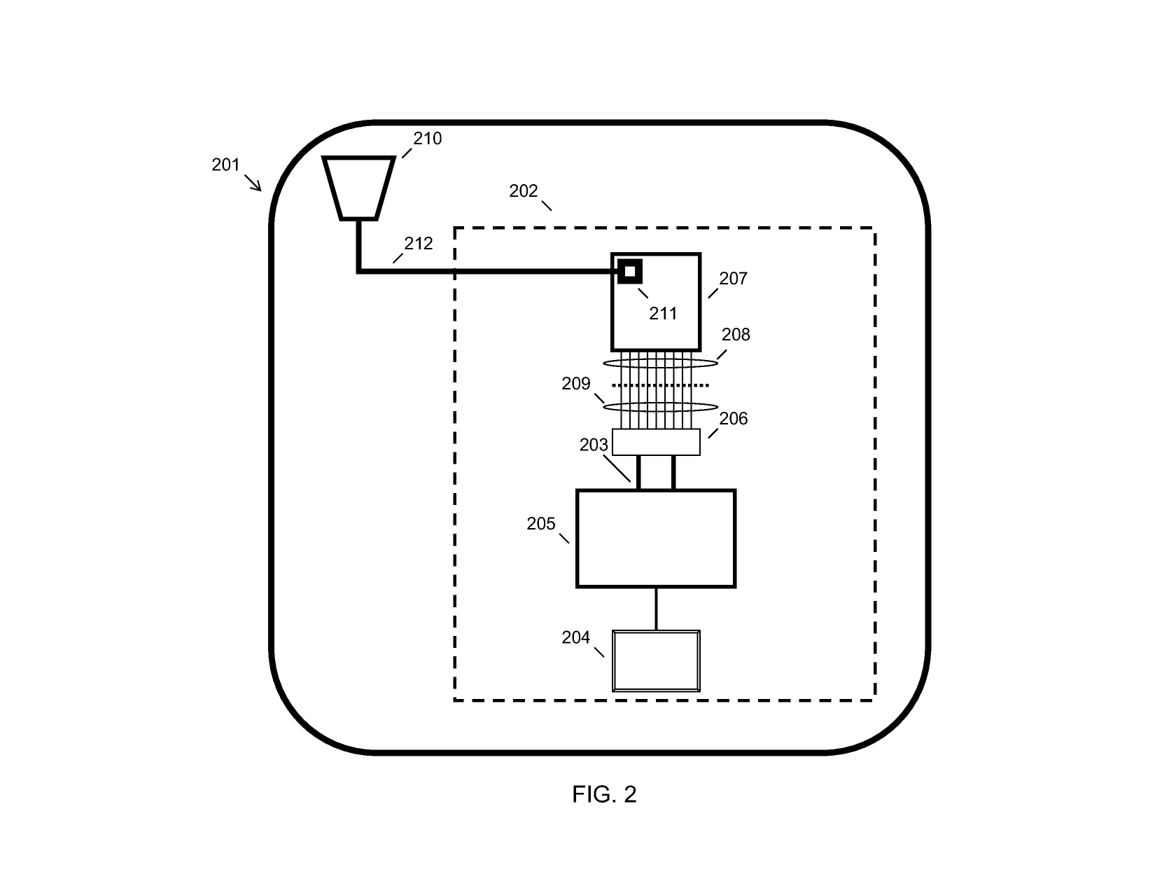

In FIG. 2, therein is provided an example information handling device comprising a device interface module configured to support wireless communication. The information handling device 201 illustrated in FIG. 2 may be implemented as any type of information handling device capable of carrying out embodiments described herein, for example, a laptop computer or tablet computing device. A system board (e.g., printed circuit board (PCB)) 202 may be arranged within the information handling device 201 and may be configured to support one or more system busses 203, CPUs 204, system controllers 205, system bus slots 206, and device interface modules 207.

As shown in FIG. 2, a system controller 205 may be operably connected to a CPU 204 and a system bus 203, for example, a PCIe or Mini PCIe bus. According to embodiments, the system controller 205 may be a Platform Controller Hub (PCH), such as the INTEL series of PCH microchips. INTEL is a registered trademark of the Intel Corporation. A device interface module 207 may be comprised of a set of pins 208 configured to facilitate communication with a specific system bus 203 (e.g., PCI, PCIe, Mini PCIe). The device interface module 207 may connect with a system bus 203 through a system bus slot 205 having a set of pins 209 defined according to a standard (e.g., the Mini PCIe standard) and configured to interface with the device interface module pins 208.

One or more wireless antennas 210 may be arranged within the information handling device 201. As an illustrative and non-restrictive example, an antenna 210 may be a multi-band antenna configured to support multiple frequency bands, such as the 3G and 4G frequency bands. The device interface module 207 may connect with an antenna 210 through an antenna connector element 211 coupled with an antenna feed line 212 (e.g., a coaxial cable).

According to embodiments, the system bus slot pins 209 may be comprised of one or more tuning pins (not shown) that may operate to tune the antenna 210 to operate in one or more particular wireless communication frequency bands. The antenna 210 may be configured to operate at a frequency band based on the configuration of pins 208 of the device interface module 207 that connect with the system bus slot pins 209 and the tuning pins in particular. As a non-limiting example, the pins 208 of the device interface module 207 may be configured to tune the antenna to operate at the Wi-Fi, 3G, 4G, or some combination thereof, frequency bands. According to embodiments, the antenna 210 supplied with the information handling device may be a 3G/4G antenna that may be tuned to operate in the Wi-Fi frequency range responsive to connecting an interface device module 207 with a set of pins 208 that connect to one or more tuning pins configured to tune the antenna 210 to operate in the Wi-Fi frequency range.

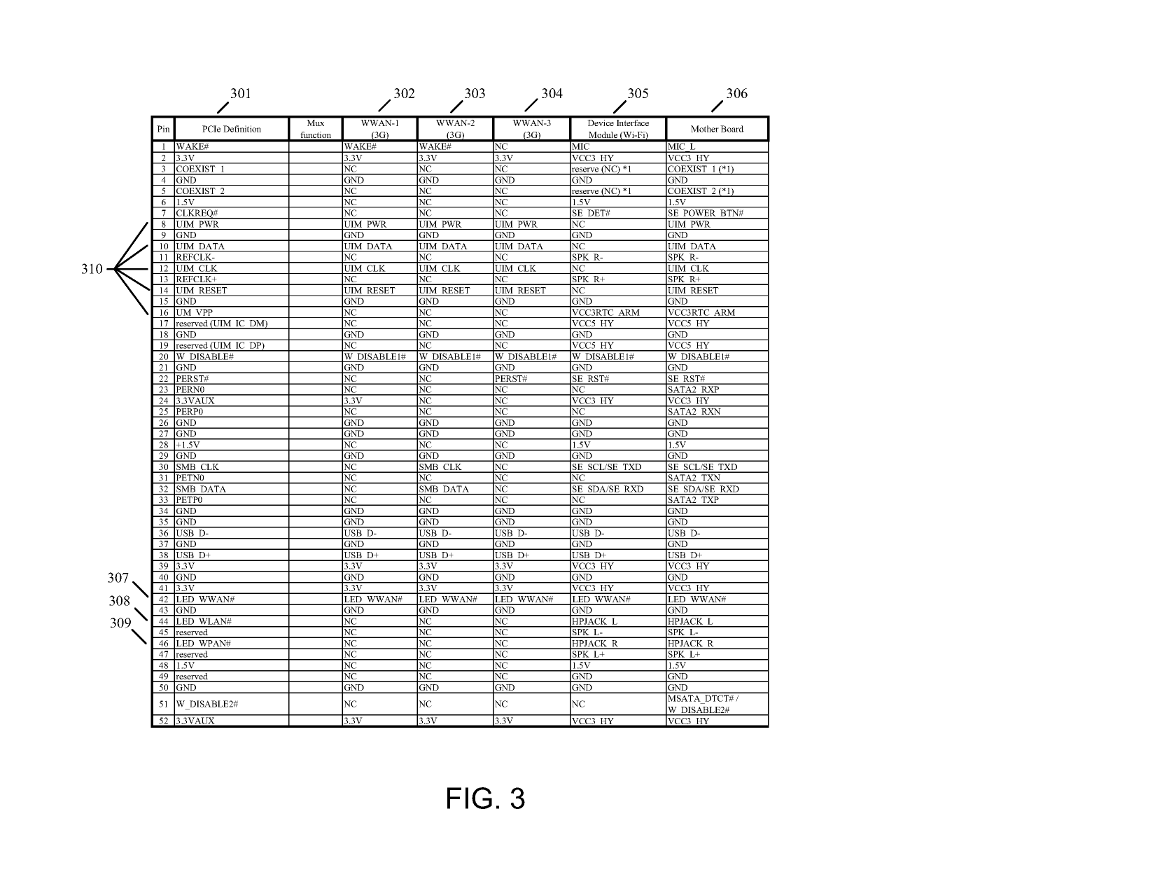

FIG. 3 provides an example diagram of a standard PCIe bus slot pin-out configuration and configurations of device interface modules according to embodiments. In the illustrative and non-restrictive example of FIG. 3, the standard bus slot and device interface modules are configured according to the Mini PCIe standard. However, embodiments are not so limited, as any system bus interface (e.g., PCI, PCIe, etc.) that may carry out embodiments as provided herein is contemplated in this disclosure.

The PCIe definition pin-out 301 comprises a standard pin assignment for a standard system bus slot arranged within an information handling device configured according to embodiments. FIG. 3 provides pin-outs 302-305 for device interface modules (e.g., Mini PCIe adapters) that may be connected to a system bus (e.g., PCIe system bus) of the information handling device through the standard bus slot 301. The device interface module (Wi-Fi) pin-out 305 may be arranged within a SOC configured according to embodiments, for example, such as the SOC comprising a processor and related hardware, firmware, and wireless communication technology support elements as provided in the description of FIG. 1, above. In addition, FIG. 3 provides a pin-out of an information handling device motherboard 306 configured according to an embodiment to interface with device interface modules described herein (e.g., WWAN-1, Device Interface Module (Wi-Fi), etc.). According to embodiments, the pin-outs may be configured to provide 3G 302-304, Wi-Fi 305, and Wi-Fi and 3G 306 wireless communication technologies.

The configuration of the pin-outs 302-306 depicted in the example of FIG. 3 facilitate the tuning of a multi-band antenna to operate according to the wireless communication technology associated with the device interface module inserted in the standard bus slot 301. Embodiments are not limited to the specific pin-out configurations shown in FIG. 3, as any pin-out configuration capable of tuning a wireless antenna utilizing the pins of a standard bus slot according to embodiments provided herein is contemplated in this description.

As shown in FIG. 3, the standard pin configuration 301 may include one or more wireless communication pins 307-310 configured to tune the frequency band of an antenna located within an information handling device. According to embodiments, an antenna may be tuned based on whether a device interface module pin is connected to one or more of the wireless communication pins 307-310. The device interface modules supporting 3G wireless communication 302,303 are not connected to the LED WLAN#308 and LED WPAN#309 standard pins, as indicated by the “NC” designation, meaning “no connection.” The 3G device interface modules 302, 303 may be connected to a set of 3G pins 310, for example, SIM card pins that facilitate interaction with a SIM card that supports 3 G communication. As a result, the antenna may be tuned to operate at the 3G frequency band responsive to connecting the 3G device interface modules 302, 303 to the standard bus slot 301. Wi-Fi wireless communication (e.g., 305 and 306) may be supported by connections to the LED WLAN#308 and LED WPAN#309 pins. Accordingly, when a device interface module supporting Wi-Fi wireless communication, such as Device Interface Module (Wi-Fi) 305, is inserted in the standard bus slot 301, the antenna may be tuned to support the Wi-Fi frequency band.

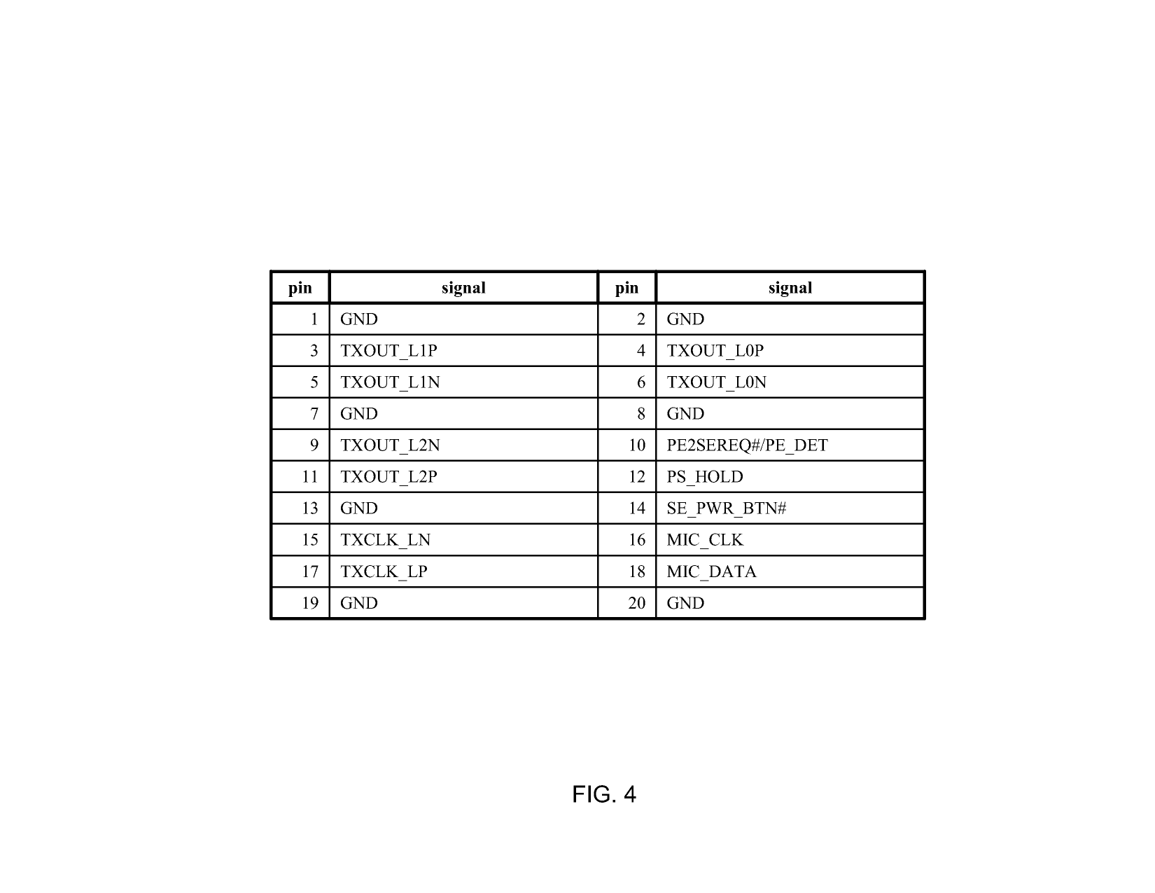

In addition to handling wireless communications, device interface modules may support certain audio and video signals, such as universal asynchronous receiver/transmitter (UART), general purpose input/output (GPIO), audio signals, and combinations thereof. According to embodiments, a 20-pin connection may be provided to support certain audio and video signals in combination with the aforementioned signals for tuning an antenna. Referring to FIG. 4, therein is provided an example pin-out for providing audio and/or video signals according to an embodiment. In FIG. 4, the exemplary pin-out may be configured for low-voltage differential signaling (LVDS) signals across a J1/J2 connector and associated flex cable. However, embodiments are not so limited as any signals capable of carrying out embodiments described herein may be utilized to carry out this exemplary feature.

Embodiments provide for a hybrid computing system comprising a primary environment (PE) (for example, a Win-Tel platform) and a secondary environment (SE) (for example, a light weight/ANDROID platform) in a single computing system. ANDROID is a registered trademark of Google Incorporated in the United States and/or other countries. The hybrid computer system includes various features, as described further herein. In and among other features, an embodiment supports the tuning of a multi-band antenna through a standard system bus slot as provided according to embodiments described herein.

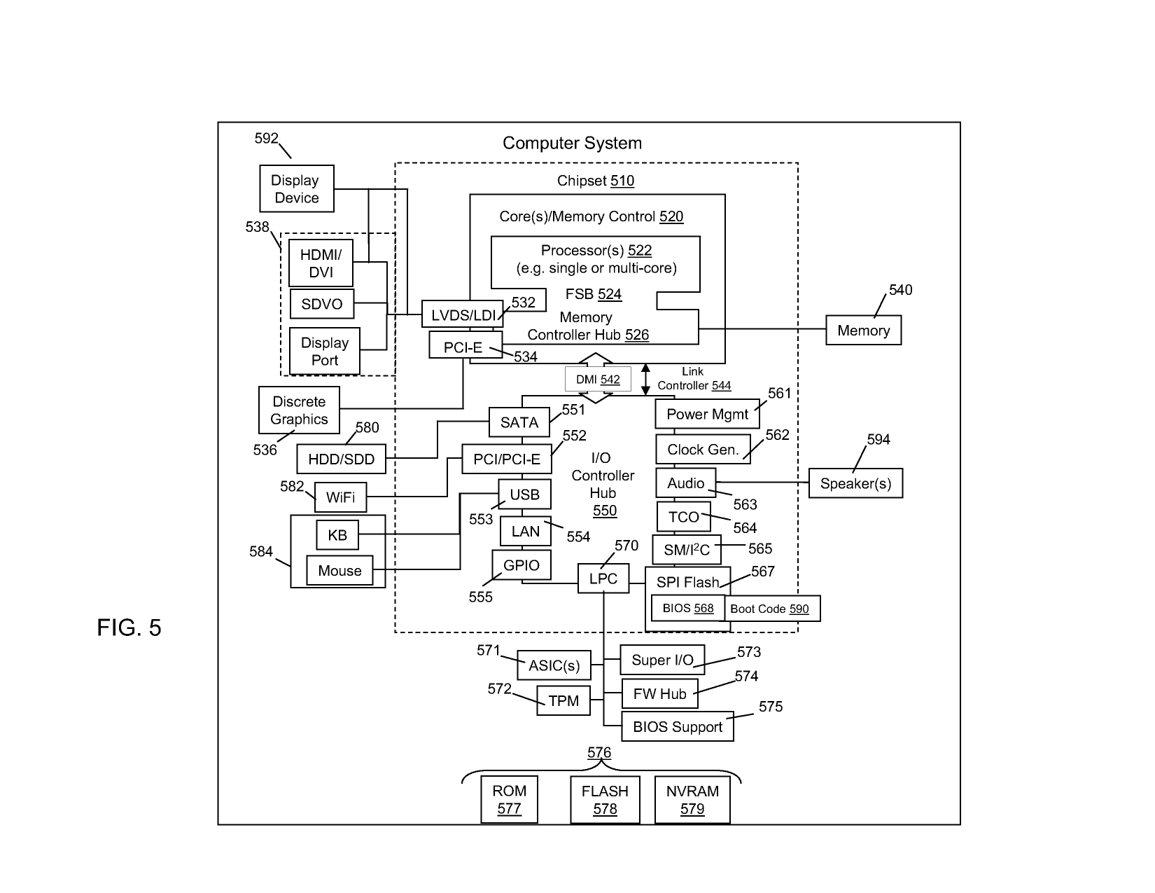

While various other circuits, circuitry or components may be utilized, FIG. 5 depicts a block diagram of one example of Win-Tel type information handling device circuits, circuitry or components. The example depicted in FIG. 5 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 5.

The example of FIG. 5 includes a so-called chipset 510 (a group of integrated circuits, or chips, that work together, chipsets) with an architecture that may vary depending on manufacturer (for example, INTEL, AMD, ARM, et cetera). The architecture of the chipset 510 includes a core and memory control group 520 and an I/O controller hub 550 that exchanges information (for example, data, signals, commands, et cetera) via a direct management interface (DMI) 542 or a link controller 544. In FIG. 5, the DMI 542 is a chip-to-chip interface (sometimes referred to as being a link between a “northbridge” and a “southbridge”). The core and memory control group 520 include one or more processors 522 (for example, single or multi-core) and a memory controller hub 526 that exchange information via a front side bus (FSB) 524; noting that components of the group 120 may be integrated in a chip that supplants the conventional “northbridge” style architecture.

In FIG. 5, the memory controller hub 526 interfaces with memory 540 (for example, to provide support for a type of RAM that may be referred to as “system memory” or “memory”). The memory controller hub 526 further includes a LVDS interface 532 for a display device 592 (for example, a CRT, a flat panel, a projector, et cetera). A block 538 includes some technologies that may be supported via the LVDS interface 532 (for example, serial digital video, HDMI/DVI, display port). The memory controller hub 526 also includes a PCI-express interface (PCI-E) 534 that may support discrete graphics 536.

In FIG. 5, the I/O hub controller 550 includes a SATA interface 551 (for example, for HDDs, SDDs, 180 et cetera), a PCIe interface 552 (for example, for wireless connections 582), a USB interface 553 (for example, for devices 584 such as a digitizer, keyboard, mice, cameras, phones, storage, other connected devices, et cetera), a network interface 554 (for example, LAN), a GPIO interface 555, a LPC interface 570 (for ASICs 571, a TPM 572, a super I/O 573, a firmware hub 574, BIOS support 575 as well as various types of memory 576 such as ROM 577, Flash 578, and NVRAM 579), a power management interface 561, a clock generator interface 562, an audio interface 563 (for example, for speakers 594), a TCO interface 564, a system management bus interface 565, and SPI Flash 567, which can include BIOS 568 and boot code 590. The I/O hub controller 550 may include gigabit Ethernet support.

The system, upon power on, may be configured to execute boot code 590 for the BIOS 568, as stored within the SPI Flash 567, and thereafter processes data under the control of one or more operating systems and application software (for example, stored in system memory 540). An operating system may be stored in any of a variety of locations and accessed, for example, according to instructions of the BIOS 568. As described herein, a device may include fewer or more features than shown in the system of FIG. 5.

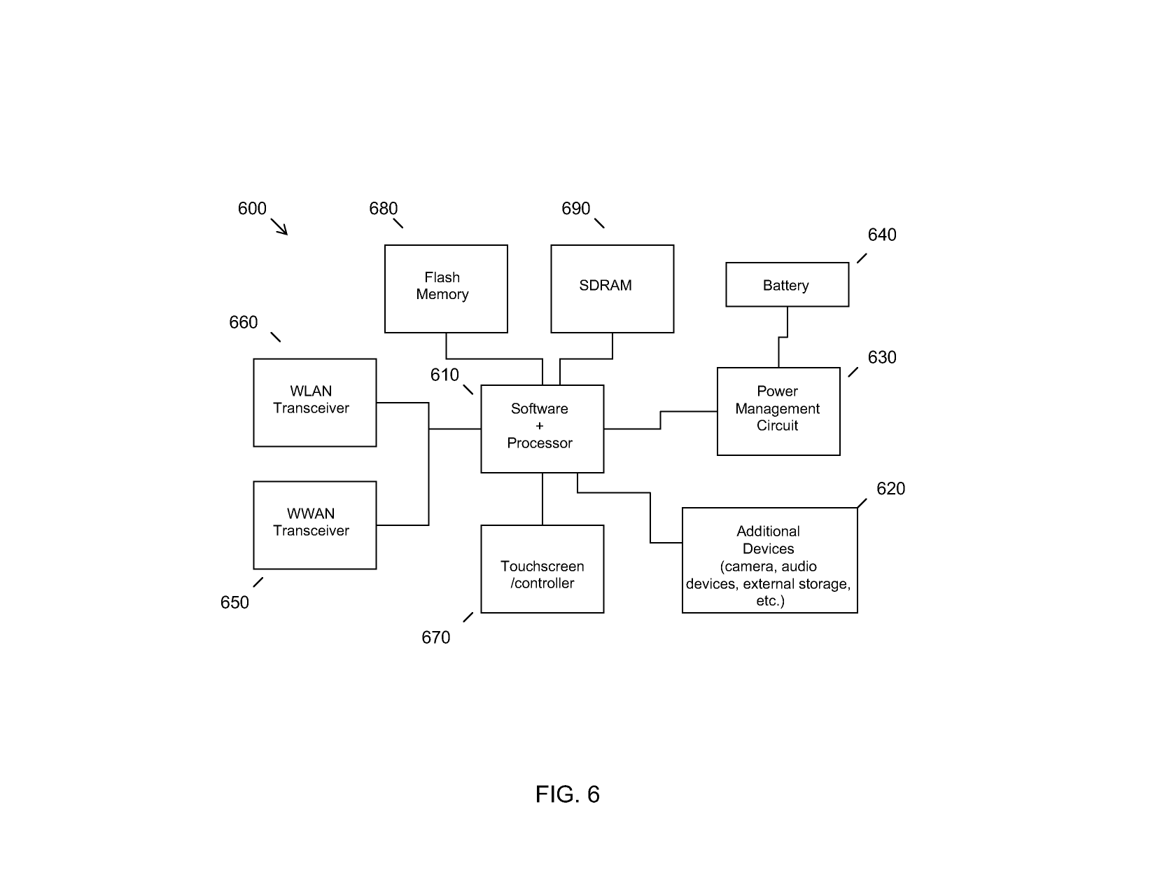

Referring to FIG. 6, with regard to smart phone and/or tablet circuitry 600, an example includes an ARM based system design, with software and processor(s) combined in a single chip 610. Internal busses and the like depend on different vendors, but essentially all the peripheral devices (620) may attach to a single chip 610. In contrast to the circuitry illustrated in FIG. 6, the tablet circuitry 600 may combine the processor, memory control, and I/O controller hub all into a single chip 610, commonly referred to a “system on a chip” (SOC). Also, ARM based systems 600 do not typically use SATA or PCI or LPC. Common interfaces for example include SDIO and I2C. There are power management chip(s) 630, which manage power as supplied for example via a rechargeable battery 640, which may be recharged by a connection to a power source (not shown), and in at least one design, a single chip, such as 610, may be used to supply BIOS like functionality and DRAM memory.

ARM based systems 600 typically include one or more wireless transceivers, including, but not limited to, WWAN 660 and WLAN 650 transceivers for connecting to various networks, such as telecommunications networks and wireless base stations. Commonly, an ARM based system 600 will include a touchscreen 670 for data input and display. ARM based systems 600 also typically include various memory devices, for example flash memory 680 and SDRAM 690.

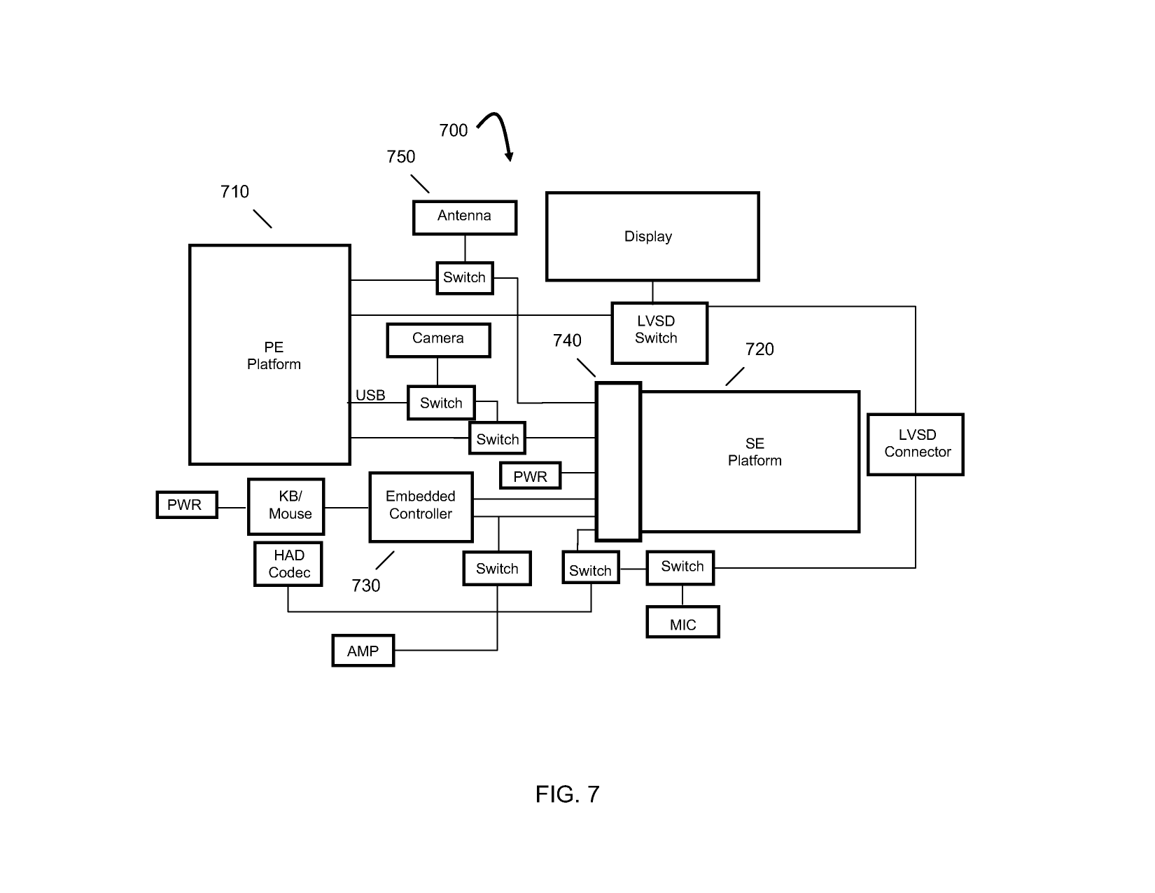

As described herein, embodiments combine components of FIG. 5 and FIG. 6 into a hybrid system. While various embodiments may take a variety of hybrid forms, FIG. 7 illustrates one example hybrid environment configured to support the tuning of a multi-band antenna through a standard system bus slot as provided according to embodiments described herein.

FIG. 7 provides an illustration of an example embodiment of a hybrid information handling device 700 (“device”). The device 700 has at least two environments or states: a primary environment (PE) and a secondary environment (SE), supported by two platforms, 710 and 720, respectively. Thus, device 700 may include a PE platform 710 similar to that described in FIG. 1, and a SE platform 720 such as that described in FIG. 2. According to embodiments, the SE platform may be comprised of the system depicted in FIG. 6 configured in a SOC form factor, for example, as a Mini PCIe adapter.

An embodiment provides a PE in which a user experiences a WINDOWS operating environment or state, and a SE in which a user experiences an ANDROID operating environment or state. In a PE, the information handling device may thus operate according to a WINDOWS operating system. In a SE, the information handling device may operate according to an ANDROID operating system. According to an embodiment, a user may switch between these two states.

The device 700 may include a display and input interfaces (for example, keyboard, mouse, touch interface, et cetera). Switching electronics (switches in FIG. 7) permit the display, touch interface, camera, microphone and similar peripherals, including the antenna 750, to be used by either the PE or SE platforms 710, 720, depending on which is the actual operating environment chosen by the user. Communications between PE platform 710 and the SE platform 720 may take place various levels. Control of machine-state, security and other related functions may be provided by an embedded controller 720 of the device 700. Communication links may use protocols like I2C or LPC. Higher bandwidth communications, such as used to move large amounts of data, for example video files, may use methods like USB, PCIe, Mini PCIe, or Ethernet.

According to embodiments, the SE platform 720 may be incorporated into the device as a device interface module, for example, a SOC module comprising an ARM processor and associated hardware, firmware, and wireless communication elements. Accordingly, embodiments provide that the SE device platform 720 may be operably connected to the device through a system bus slot 730, for example, a Mini PCIe slot. The SOC module may be configured for wireless communication using one or more wireless communication technologies, including, but not limited to Wi-Fi. Accordingly, embodiments provide that the device system bus pin-outs (not shown) may be configured to tune the antenna 750, for example, a multi-band 3G/4G antenna, to operate in the frequency band associated with the SOC module, such as the Wi-Fi frequency band.

When the device 700 is in the SE mode or state, the device 700 operates as an independent tablet computer. As such, the SE platform 720 and the lightweight/tablet operating system executed therewith, such as an ANDROID operating system, control the operation of the device 700, including the display, peripherals such as a camera, microphone, speaker, shared wireless antenna, accelerometer, SD card, other similar peripheral devices, and software applications.

The device 700 utilizes the PE platform 710 when the user selects such an operational state, and this operational state may be set as a default or an initial state. When in the PE state, the device 700 is controlled by a PE platform 710, including for example a WINDOWS operating system. Essentially, the device 700 becomes a conventional laptop computer when PE platform 710 controls operation. As such, the SE platform 720 does not control device 700, peripherals, et cetera, when the device 700 is in the PE state, though an ANDROID operating system of SE platform 720 may be running in the PE state, as further described herein.

In such a hybrid environment, there are thus essentially two computing systems within one device 700, that is a primary system (running in the PE), and a secondary system (running in the SE). These systems may share access to various hardware, software, peripheral devices, internal components, et cetera, depending on the state (PE or SE). Each system is capable of operating independently.

According to an embodiment, a user may switch between the PE and SE environments, for example, through one or more hardware switches that switch hardware from being controlled or physically attached to one environment to being controlled or physically attached to a second environment. Switched hardware may include, but is not limited to, a display, microphone, mouse, keyboard, touchpad, microphone, storage devices, and USB devices. Embodiments provide that when an environment (e.g., SE) is in control of the hybrid device, the other environment (e.g., PE) may be placed in a standby mode. As such, each environment may operate independently of the power state of the other environment.

Additional embodiments provide for switching responsive to one or more user actions, such as opening one or more applications, accessing a certain file type, connecting or disconnecting a device (e.g., camera), or responsive to one or more device states, such as a low battery state. A non-limiting example provides that the hybrid device may switch from the PE state to the SE state responsive to a user opening certain media files (e.g., a movie file), such that the user may execute the file in a lower-power environment.

Embodiments may be implemented in one or more information handling devices configured appropriately to execute program instructions consistent with the functionality of the embodiments as described herein. In this regard, FIGS. 5-7 illustrate non-limiting examples of such devices and components thereof. While mobile information handling devices such as tablet computers, laptop computers, and smart phones have been specifically mentioned as examples herein, embodiments may be implemented using other systems or devices as appropriate.

As will be appreciated by one skilled in the art, various aspects may be embodied as a system, method or computer (device) program product. Accordingly, aspects may take the form of an entirely hardware embodiment or an embodiment including software that may all generally be referred to herein as a “circuit,” “module” or “system.” Furthermore, aspects may take the form of a computer (device) program product embodied in one or more computer (device) readable medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection.

Aspects are described herein with reference to the figures, which illustrate example methods, devices and program products according to various example embodiments. It will be understood that the actions and functionality illustrated may be implemented at least in part by program instructions. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified.

The program instructions may also be loaded onto a device to cause a series of operational steps to be performed on the device to produce a device implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An information handling device comprising:
one or more processors;
one or more memories storing program instructions accessible by the one or more processors;
one or more wireless antennas; and
a system bus slot comprising one or more antenna tuning pins configured to tune the one or more wireless antennas to operate within a frequency band based on one or more connections with one or more wireless communication pins of a device interface module;
wherein, responsive to execution of program instructions accessible to the one or more processors, the one or more processors are configured to execute wireless communications for the information handling device utilizing the one or more wireless antennas operating within the frequency band.

2. The information handling device according to claim 1, wherein the one or more wireless antennas are multi-band antennas configured to operate in a plurality of wireless frequency bands.

3. The information handling device according to claim 2, wherein the plurality of wireless frequency bands comprise third generation and fourth generation frequency bands.

4. The information handling device according to claim 1, wherein the system bus slot comprises a Mini Peripheral Component Interconnect Express slot.

5. The information handling device according to claim 4, wherein the device interface module comprises a Mini Peripheral Component Interconnect Express adapter.

6. The information handling device according to claim 1, wherein the one or more wireless antennas are tuned to operate in the Wi-Fi frequency band.

7. A hybrid information handling device comprising:
a first processor configured to operate within a primary environment;
a second processor configured to operate within a secondary environment;
one or more memories storing program instructions accessible by the first and second processors;
one or more wireless antennas; and
a system bus slot comprising one or more antenna tuning pins configured to tune the one or more wireless antennas based on one or more connections with one or more wireless communication pins of the device interface module;
wherein the hybrid information device is configured to switch between the primary environment and the secondary environment;
wherein, responsive to execution of program instructions accessible to the first processor, the first processor is configured to execute wireless communications for the information handling device utilizing the one or more wireless antennas operating within a primary environment wireless communication frequency band;
wherein, responsive to execution of program instructions accessible to the second processor, the second processor is configured to execute wireless communications for the information handling device utilizing the one or more wireless antennas operating within a secondary environment wireless communication frequency band.

8. The hybrid information handling device according to claim 7, wherein the one or more wireless antennas are multi-band antennas configured to operate in a plurality of wireless frequency bands.

9. The hybrid information handling device according to claim 8, wherein the plurality of wireless frequency bands comprise third generation and fourth generation frequency bands.

10. The hybrid information handling device according to claim 7, wherein the system bus slot comprises a Mini Peripheral Component Interconnect Express slot.

11. The hybrid information handling device according to claim 10, wherein the device interface module comprises a Mini Peripheral Component Interconnect Express adapter.

12. The hybrid information handling device according to claim 7, wherein the secondary environment wireless communication frequency band comprises the Wi-Fi frequency band.

13. The hybrid information handling device of claim 7, wherein the secondary environment platform comprises a system on chip architecture.

14. The hybrid information handling device of claim 7, wherein said primary operating environment is implemented on a primary environment platform.

15. A method comprising:
tuning one or more wireless antennas connected to an information handling device via one or more antenna tuning pins arranged within a system bus slot;
wherein the one or more antenna tuning pins are configured to tune the one or more wireless antennas to operate within a frequency band based on one or more connections with one or more wireless communication pins of a device interface module arranged to interface with the system bus slot.

16. The method according to claim 15, wherein the one or more wireless antennas are multi-band antennas configured to operate in a plurality of wireless frequency bands.

17. The method according to claim 16, wherein the plurality of wireless frequency bands comprise the third generation and fourth generation frequency bands.

18. The method according to claim 15, wherein the system bus slot comprises a Mini Peripheral Component Interconnect Express slot.

19. The method according to claim 18, wherein the device interface module comprises a Mini Peripheral Component Interconnect Express adapter.

20. The method according to claim 15, wherein the one or more wireless antennas are tuned to operate in the Wi-Fi frequency band.
